(19) United States
(12) Patent Application Publication
(10) Pub. No.: US 2016/0207137 A1
(43) Pub. Date: Jul. 21, 2016

(54) Method and Systems to Utilize Network Communications to Synchronize Welders and Avoid Interference

(71) Applicant: LINCOLN GLOBAL, INC., CITY OF INDUSTRY, CA (US)

(72) Inventor: EDWARD ENYEDY, EASTLAKE, OH (US)

(21) Appl. No.: 14/601,334

(22) Filed: Jan. 21, 2015

(51) Int. Cl. B23K 9/10; B23K 9/095

(52) U.S. Cl. CPC B23K 9/1068; B23K 9/0953

(57) ABSTRACT

The invention described herein generally pertains to a system and method related to reducing magnetic interference between two or more arcs within a geographic proximity to one another performing a welding operation on a workpiece. In an embodiment, a first waveform used to create a first arc on the workpiece and a second waveform used to create a second arc on the workpiece can have a respective phase separated by a number of degrees. In an embodiment, a parameter of a waveform can be adjusted for one or more arcs that are within a geographic proximity to one another in order to avoid interference.

### TECHNICAL FIELD

In general, the present invention relates to a welding system. More particularly, the present invention relates to welding systems that coordinate waveforms to avoid interference when in geographic proximity to one another.

### BACKGROUND OF THE INVENTION

Often, welding systems collaborate and create arcs on a workpiece at the same time and in close proximity to one another. Since each welding system creates an arc, each arc is capable of causing a magnetic interference to one another. The use of multiple arcs on the same workpiece is often unavoidable on large workpieces that require more than one welding system.

### SUMMARY OF THE INVENTION

In accordance with an embodiment of the present invention, a system is provided that includes one or more welding power supplies which provide an alternating current in the form of one or more welding waveforms to a first electrode and a second electrode to respectively create a first arc between the first electrode and a workpiece and a second arc between second electrode and the workpiece during a welding operation. The one or more welding waveforms includes a first welding waveform used with the first arc at a frequency and a second welding waveform used with the second arc at the frequency, each welding waveform having a respective peak current, and the first arc and the second arc are within a geographic proximity to one another during the welding operation on the workpiece. The system further includes a waveform manager component that is configured to identify the geographic proximity of the first arc and the second arc, and based on the geographic proximity, adjust a time of occurrence for each respective peak current of the first welding waveform or the second welding waveform such that each respective peak current occurs at a different time during the welding operation on the workpiece, the adjust of the time prevents a magnetic field interference between the first arc and the second arc on the workpiece during the welding operation.

In accordance with an embodiment of the present invention, a method is provided that includes at least the steps of: creating a first arc with a first waveform between a first electrode and a workpiece; creating a second arc with a second waveform between a second electrode and the workpiece within a geographic proximity of the first arc; identifying at least one of a rising edge on a portion of the first waveform or a rising edge on a portion of the second waveform; and shifting at least the first waveform or the second waveform by a number of degrees so the rising edge on the portion of the first waveform does not occur with the rising edge of the portion of the second waveform.

In accordance with an embodiment of the present invention, a welder system is provided that includes at least the following: a first welder that creates a first arc with a first waveform between a first electrode and a workpiece; a second welder that creates a second arc with a second waveform between the second electrode and the workpiece; a proximity detector component that is configured to identify a geographic proximity between the first arc and the second arc performing a welding operation on the workpiece; a waveform manager component that is configured to identify a first frequency for the first waveform and a second frequency for the second waveform; if the first frequency is equal to the second frequency, the waveform manager component is further configured to adjust a time of occurrence for each respective peak current of the first welding waveform or the second welding waveform such that each respective peak current occurs at a different time during the welding operation on the workpiece; and if the first frequency is not equal to the second frequency, the waveform manager component is further configured to adjust one of a phase of the first waveform or a phase of the second waveform such that a rising edge of a portion of the first waveform does not occur during a rising edge of a portion of the second waveform.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a diagram that illustrates a welding system in accordance with the subject innovation;

FIG. 2 is a diagram that illustrates a welding system in accordance with the subject innovation;

FIG. 3 is a diagram that illustrates a welding system in accordance with the subject innovation;

FIG. 4 is a diagram that illustrates a welding system in accordance with the subject innovation;

FIG. 5 is a diagram that illustrates a flow diagram for a welding system in accordance with the subject innovation;

FIG. 6 is a diagram that illustrates a flow diagram for a welding system in accordance with the subject innovation;

FIG. 7 is a diagram that illustrates a flow diagram for a welding system in accordance with the subject innovation; and

FIG. 8 is a diagram that illustrates a flow diagram for a welding system in accordance with the subject innovation.

### DETAILED DESCRIPTION OF THE INVENTION

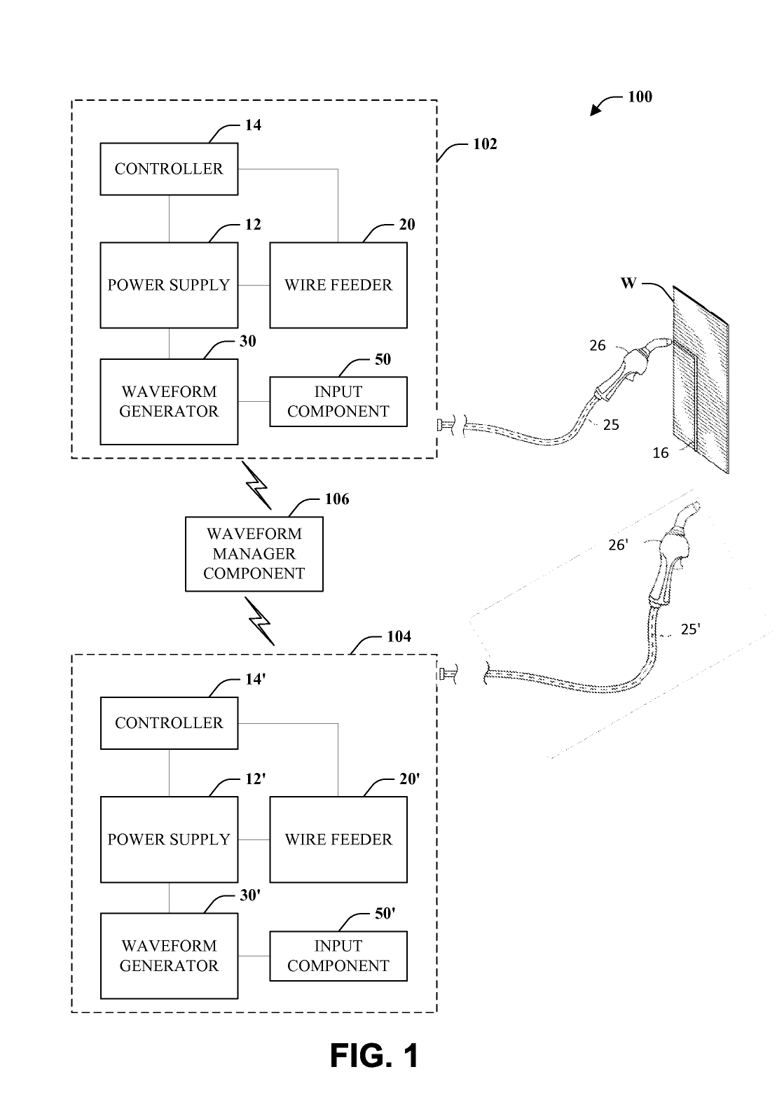

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 1-4 (among others) illustrates a welding system that is used with an automated or semi-automated welding system.

Embodiments of the invention relate to methods and systems that relate to adjusting one or more waveforms or a phase of one or more waveforms to avoid interference (e.g., magnetic interference caused by one or more magnetic fields associated with each arc) between two or more arcs created on a workpiece within a geographic proximity to each other. A waveform manager component is provided that can create a phase slot that is assigned to waveforms that create arcs on a workpiece that are within a geographic proximity to one another. In particular, the waveform manager component can communicate wirelessly to assign waveforms to pre-defined phase slots or dynamically assign waveforms to phase slots as arcs are introduced within the defined geographic proximity. In still another embodiment, an interference detection component can be used to identify an amount of interference that triggers employment of the waveform manager component to adjust a phase of one or more waveforms used to create arcs on the workpiece.

In an embodiment, the interference can occur with a SAW application which can employ multiple arcs to increase deposition rates. The subject innovation can be utilized with a multiple arc system, wherein the multiple arc system can include magnetic forces created by like and opposing weld currents of adjacent arcs. These adjacent arcs can result in arc interaction that can physically push or pull the arc columns together. To counteract this effect, the phase relationship between adjacent arcs can be automatically set by the waveform manager component to alternate and equalize the duration of magnetic push and pull forces. In an embodiment, the waveform manager component can synchronizing cables which provide a net result is of cancellation of the interacting forces.

“Welding” or “weld” as used herein including any other formatives of these words will refer to depositing of molten material through the operation of an electric arc including but not limited to gas shielded flux cored arc welding (G-FCAW), submerged arc, GTAW, GMAW, MAG, MIG, TIG welding, or any electric arc used with a welding system. Moreover, the welding operation can be on a workpiece that includes a coating such as, but not limited to, a galvanized coating.

Magnetic arc blow can be caused by a magnetic field inherent in the workpiece W. The workpiece being any material that is to be welded. Excessive magnetic arc blow can result in defects within the weld and slow down production. Moreover, an arc can cause magnetic interference to another arc when within a geographic proximity. By way of example and not to be limiting on the subject innovation, a geographic proximity can be defined as within fifteen (15) feet. However, it is to be appreciated that this geographic proximity definition can be greater or less than fifteen (15) feet depending on welding parameters or other variables in the welding system, wherein the welding parameters can be, but are not limited to, the material of the workpiece (e.g., steel, aluminum, nickel steel, nickel steel alloys, metallic alloys, among others), a type of welding operation, a type of electrode, a wire feed speed, a current, a voltage, a peak voltage, a peak current, a waveform, a power, and the like.

In accordance with the present invention, a welding system, generally indicated by 100 is illustrated in FIG. 1. Welding system 100 can include first welder 102 (also referred to as “welder system 102” and “first welder system 102”) and second welder 104 (also referred to as “welder system 104” and “second welder system 104”) that can create one or more arcs between an electrode and workpiece W, wherein a portion of first welder 102 and a portion of second welder 104 are within geographic proximity to one another such that a magnetic interference exists due to the distance of arcs. For example, the geographic proximity between the portion of the first welder 102 and the portion of the second welder 104 such that the portion of the first welder 102 or the portion of the second welder 104 can be, a torch, the controller, a ground connection, a power supply, a wire feeder, a waveform generator, an input component, a component configured to communicate a geographic location (e.g., affixed to a workpiece, affixed to a portion of the first welder 102 or a portion of the second welder 104, incorporated into the first welder 102 or the second welder 104, among others), a separate electronic device that is configured to communicate with the waveform manager component 106 or one of the first welder 102 or the second welder 104, among others.

First welder 102 and second welder 104 can create a first arc and a second arc respectively. First welder 102 and second welder 104 are described below. First welder 102 is described having controller 14, power supply 12, wire feeder 20, waveform generator 30, and input component 50. Additionally, second welder 104 is described having controller 14′, power supply 12′, wire feeder 20′, waveform generator 30′, and input component 50′. Although first welder 102 and second welder 104 are depicted, the subject innovation can be employed with two or more welders such that a waveform of each welder can be adjusted to avoid magnetic interference between one another when two or more of the welders are within a geographic proximity of one another. Moreover, it is to be appreciated that first welder 102 can create a first arc between an electrode and workpiece W to create weld 16 and that second welder 104 can create a second arc between an electrode and workpiece W to continue weld 16 or create an additional weld on workpiece W.

First welder 102 includes controller 14 that is configured to perform a welding operation on a workpiece W to create a weld 16. First welder 102 includes torch 26 having an electrode in which power supply 12 creates a first arc between electrode and workpiece W to complete an electrical circuit to perform the welding operation. First welder 102 can include power supply 12 that is configured to create the first arc between an electrode and workpiece W, wherein wire feeder 20 is configured to deliver welding wire to a puddle formed by the electrode. First welder 102 can include power supply 12 that provides a constant voltage welding process in an alternating current (AC) mode such that when transitioning from a positive current to a negative current, the current transitions through zero. Controller 14 can be configured to manage at least one of a wire feed speed (WFS) of wire feeder 20, power supply 12 that creates arc, waveform generator 30 that creates and/or outputs a waveform for the welding operation, and/or input component 50 that receives an input related to the welding operation performed by first welder 102. By way of example and not limitation, the input can be, but is not limited to, a distance that is the defined geographic proximity between the first welder 102 and the second welder 104, a distance between two or more welders that may cause magnetic interference between one another, a phase slot for a waveform, a phase shift between two or more waveforms, a timing shift between two or more waveforms, an input related to a welding parameter, among others.

Second welder 104 includes controller 14′ that is configured to perform a welding operation on the workpiece W to create an additional weld or supplement weld 16. Second welder 104 includes torch 26′ having an electrode in which power supply 12′ creates a second arc between electrode and workpiece W to complete an electrical circuit to perform the welding operation. Second welder 104 can include power supply 12′ that is configured to create the second arc between an electrode and workpiece W, wherein wire feeder 20′ is configured to deliver welding wire to a puddle formed by the electrode. Second welder 104 can include power supply 12′ that provides a constant voltage welding process in an alternating current (AC) mode such that when transitioning from a positive current to a negative current, the current transitions through zero. Controller 14′ can be configured to manage at least one of a wire feed speed (WFS) of wire feeder 20′, power supply 12′ that creates arc, waveform generator 30′ that creates and/or outputs a waveform for the welding operation, and/or input component 50′ that receives an input related to the welding operation performed by second welder 104 By way of example and not limitation, the input can be, but is not limited to, a distance that is the defined geographic proximity between the first welder 102 and the second welder 104, a distance between two or more welders that may cause magnetic interference between one another, a phase slot for a waveform, a phase shift between two or more waveforms, a timing shift between two or more waveforms, an input related to a welding parameter, among others.

Waveform manager component 106 can be configured to be in wireless or wired connectivity with first welder 102 and second welder 104 in order to adjust a parameter related to one or more waveforms used to perform one or more welding operations. Waveform manager component 106 can be configured to receive data related to a waveform for a welder and/or communicate data to a welder in which the data is representative of an adjustment to a parameter related to one or more waveforms used to perform a welding operation. In particular, the parameter can be a phase of the waveform. Waveform manager component 106 can create one or more phase slots for a welder such that, upon determination that two or more welders are within a geographic proximity of one another, the waveform for the welder is assigned to a particular phase slot. By way of example and not limitation, a phase slot can be determined by dividing 360 by the number of welders that are in geographic proximity of one another. It is to be appreciated that a phase slot or adjustment of a waveform for one or more welders can be pre-defined, dynamically performed, or a combination thereof. For example, a welder can have a pre-defined number of phase slots in which as a welder is introduced within the geographic proximity, a pre-defined phase slot is assigned to the welder introduced. In another example, as a welder is introduced into the geographic proximity, phase slots are created and assigned dynamically and/or on-the-fly.

Thus, for two (2) welders within geographic proximity, waveform manager component 106 can have two (2) phase slots that are 180 degrees shifted or out of phase. In an example of three (3) welders within geographic proximity, waveform manager component 106 can have three (3) phase slots that are 120 degrees shifted or out of phase. In an example having four (4) welders within geographic proximity, waveform manager component 106 can have four (4) phase slots that are 90 degrees shifted or out of phase. In an embodiment, waveform manager component 106 can utilize a lookup table or a database that stores data related to assigning a phase slot. For instance, a database can store defined distances for what is considered to be a geographic proximity, a phase shift, a number of degrees for each welder, a phase shift for a defined number of welders within geographic proximity, among others. By adjusting each waveform to being a number of degrees out of phase or shifted, magnetic interference between each arc and/or welder can be avoided. In particular, a peak current for a waveform can occur without occurring at a time when a peak current for another waveform.

In still another embodiment, waveform manager component 106 can assign a greater amount of phase shift to two welders that are closer in geographic proximity. Thus, if a first welder was separated to a second welder by 5 feet and a third welder was separated by the first welder and the second welder by 10 feet, a larger phase shift can be used between the first welder and the second welder since the distance is smaller when compared to the distance between the third welder.

Waveform manager component 106 can define a pre-defined distance that is a geographic proximity which defines a distance that may cause interference between two or more welders and/or arcs. In another embodiment, a geographic proximity can be defined by a user via input component (discussed above). In another embodiment, a user can report or notify when an interference occurs or may occur which can allow waveform manager component 106 to adjust the defined geographic proximity.

In an embodiment, waveform manager component 106 can evaluate a frequency of each welder within the geographic proximity which would cause magnetic interference. If a frequency between first welder 102 and second welder 104 is the same, a phase shift or number of degrees can be used to phase out so as to avoid a peak current of the first welder occurring when a peak current of the second welder 104 occurs. If a frequency between first welder 102 and second welder 104 is not the same, waveform manager component 106 can adjust a parameter of a first waveform of first welder 102 or a second waveform of second welder 104 to avoid a rising edge of the first waveform occurring when a rising edge of the second waveform occurs. It is to be appreciated that the parameter of a waveform can be, but is not limited to being, a peak voltage, a peak current, a waveform type (e.g. sine wave, square wave, triangular waveform, pulse waveform, surface tension transfer (STT) waveform, etc.), amplitude, frequency, time, duration, among others.

Waveform manager component 106 can be a stand-alone component (as depicted), incorporated into first welder 102, incorporated into second welder 104, incorporated into a network (e.g., wired network, wireless network, etc.), incorporated into a cloud computing environment, affixed to or incorporated into a controller, affixed to or incorporated into a torch, affixed to or incorporated into a workpiece, affixed to or incorporated into a power supply, affixed to or incorporated into an input component, affixed to or incorporated into a waveform generator, affixed to or incorporated into a wirefeeder, or any combination thereof.

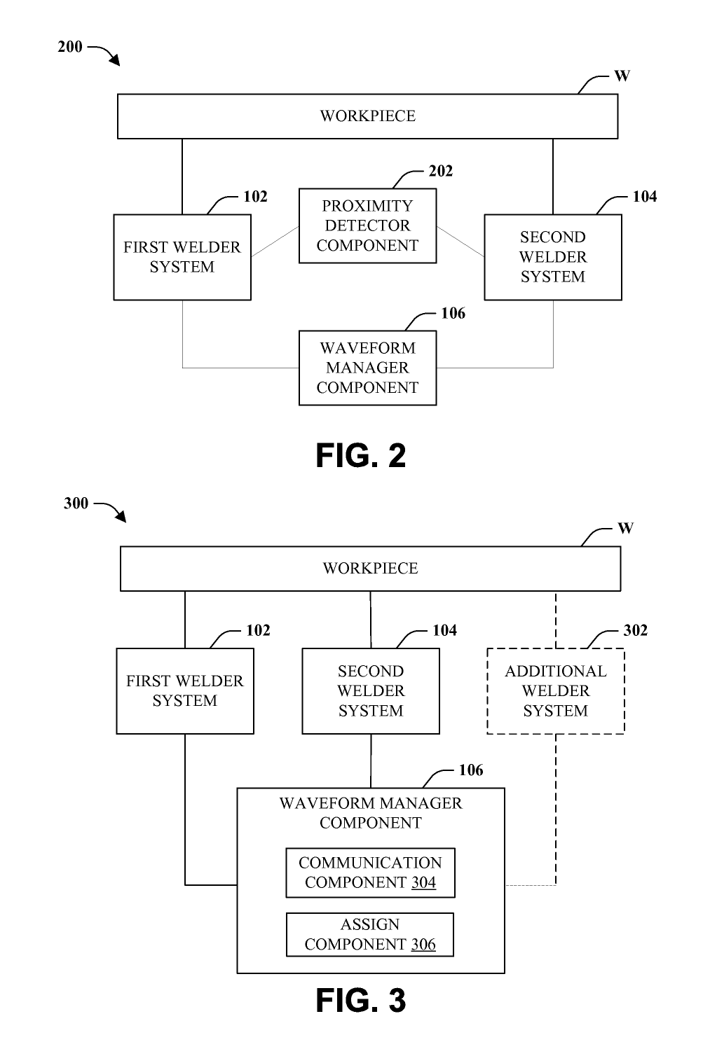

Turning to FIG. 2, system 200 is illustrated that includes first welder system 102 and second welder system 104 that utilize respective waveforms to create arcs to perform welding operations on workpiece W, wherein waveform manager component 106 is configured to adjust a parameter of the respective waveforms to avoid magnetic interference when first welder system 102 and second welder system 104 are within a geographic proximity of one another. System 200 can include a proximity detector component 202 that is configured to collect data representative of a distance between two or more welder systems, and in particular, between two or more arcs created on workpiece W to perform welding operations. Moreover, proximity detector component 202 can be configured to communicate the distance between two or more arcs and/or welders to waveform manager component 106 from which an adjustment to a waveform can be generated based on the distance being the geographic proximity that may cause interference. Proximity detector component 202 can be a stand-alone component (as depicted), incorporated into first welder system 102, incorporated into second welder system 104, affixed to or incorporated into workpiece, incorporated into waveform manager component 106, and/or a combination thereof. In an embodiment, proximity detector component 202 can communicate wirelessly to waveform manager component 106 to communicate data related to a distance between two welder systems and/or two arcs created on workpiece W. For example, proximity detector component 202 can utilize the following to identify a geographic location of an arc and/or a welder system: Global Positioning System (GPS); wireless signal data on a wireless network; cellular signal; triangulation techniques with a wireless signal; user input; among others.

FIG. 3 illustrates system 30 that includes first welder system 102, second welder system 104, and additional welder system 302. Waveform manager component 106 can be configured to adjust a parameter of a waveform used by a welder system (e.g., first welder system 102, second welder system 104, additional welder system 302) based on being within a geographic proximity to one another which can lead to magnetic interference on workpiece W while performing a welding operation.

In an embodiment, waveform manager component 106 can pre-define a set of phase slots for welder systems. In such an embodiment, phase slots can be created and assigned as a welder system is introduced within the geographic proximity for workpiece W. In such an example, a number of welder systems can be defined and each phase slot can be a limited number. System 300 can be configured for four (4) welder systems in which four (4) phase slots are created. As first welder system 102 and second welder system 104 are identified within the geographic proximity of one another, a phase slot is assigned to each. Upon detection of additional welder system 302 being within the geographic proximity, one of the set of phase slots can be assigned thereto.

It is to be appreciated that waveform manager component 106 can create phase slots dynamically as well. In such an example, upon detection of a welder system being within the geographic proximity, waveform manager component 106 adjusts a parameter of a waveform for each welder system that may cause interference to one another. For example, a phase of the waveform can be a parameter that is adjusted when a welder system is detected within the geographic proximity.

Waveform manager component 106 can include communication component 304 and assign component 306. Communication component 304 can be configured to transmit data representative of an adjustment to a parameter of a waveform for a welder system. In addition, communication component 304 can be configured to receive data representative of a setting of a parameter for a waveform of a welder system. Communication component 304 can request data representative of a setting for a parameter for a waveform from a welder system when the welder system is within a geographic proximity. Upon evaluation of the data, waveform manager component 106 can create an adjustment of the waveform and communication component 304 can transmit data representative of the adjustment to the welder system so as to avoid interference between welder systems within the geographic proximity.

Assign component 306 can be configured to create a set of phase slots and/or assign a phase slot to a welder system. Assign component 306 can be configured to provide the set of phase slots pre-defined for a group of welder systems or create and provide the set of phase slots dynamically. For example, assign component 306 can receive data representative of additional welder system 302 that is within the geographic proximity and can assign a phase slot to the additional welder system 302 (as the set of phase slots were pre-defined). In another example, assign component 306 can receive data representative of additional welder system 302 that is within the geographic proximity and can re-create a set of phase slots and assign a phase slot to the additional welder system 302 (as the set of phase slots are dynamically calculated).

In another embodiment, a queue can be utilized in which allows a welder system to be put in a hold pattern while calculations for adjustments of a parameter of waveforms are performed. The queue allows a welder system to be activated to perform a welding operation on the workpiece W after the welder system is introduced within the geographic proximity as it will be configured without disrupting the welding operation(s) being performed by welder systems within the geographic proximity.

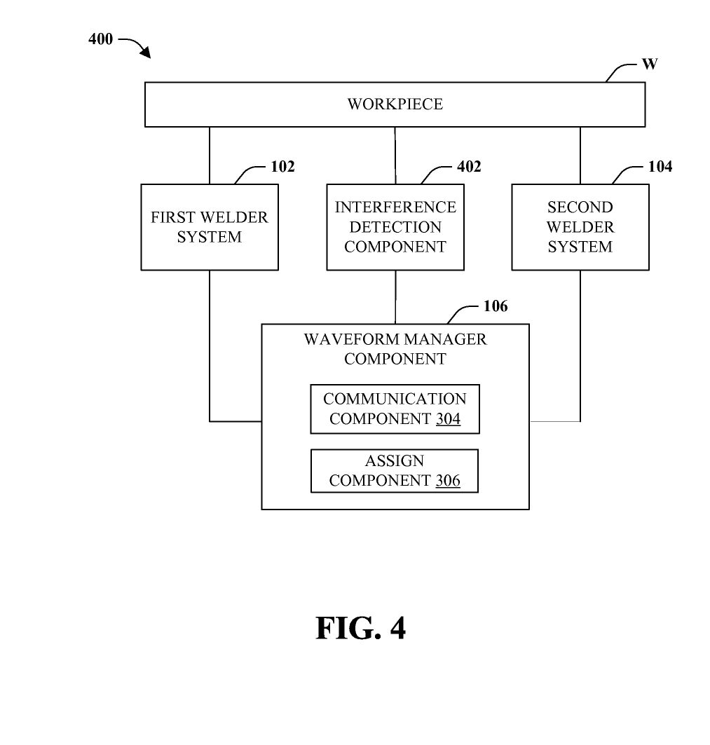

FIG. 4 illustrates system 400 that includes interference detection component 402 that is configured to detect an amount of magnetic interference between at least two or more arcs performing welding operations on workpiece W. Interference detection component 402 is configured to monitor performance of first welder system 102 and second welder system 104 to determine whether a magnetic interference occurs due to arcs created by one of the welder systems. For instance, the interference detection component 402 can be a magnetic field sensor coupled to the workpiece W. In another example, a gauss sensor can be used to detect the presence of the magnetic field and/or field strength. It is to be appreciated that one or more interference detection components 402 can be used with the subject innovation. In general, interference detection component 402 can provide a data signal to waveform manager component 106 which can trigger waveform manager component 106 to adjust or re-adjust a parameter of a waveform of first welder system 102, second welder system 104, or another welder system introduced within the geographic proximity.

In an embodiment, the geographic proximity is identified by a user input. In an embodiment, the subject innovation can further include a first torch that delivers a wire to a puddle created by the first arc on the workpiece and a second torch that delivers a wire to a puddle created by the second arc on the workpiece. In an embodiment, the geographic proximity is identified by a wireless signal communicated by the first torch and the second torch. In an embodiment, the geographic proximity is greater than approximately one (1) foot and less than approximately fifteen (15) feet. In an embodiment, the geographic proximity is less than approximately one (1) foot and less than approximately ten (10) feet.

In an embodiment, the subject innovation can further include a communication component that is configured to receive at least one of data representative of the first waveform, data representative of the second waveform, data representative of a parameter of the first waveform, or data representative of a parameter of the second waveform. In an embodiment, the communication component is further configured to communicate data representative of the time of occurrence to each of the one or more welding power supplies. In an embodiment, the subject innovation can further include an assign component that is configured to generate a phase slot for each waveform used by the one or more welding power supplies, wherein each phase slot is a number of degrees out of one another. In an embodiment, the number of degrees is 180.

In an embodiment, the subject innovation can further include a third electrode that creates a third arc on the workpiece using a third waveform within the geographic proximity of at least one of the first arc or the second arc, wherein the number of degrees is 120. In an embodiment, the subject innovation can further include a third electrode that creates a third arc on the workpiece using a third waveform within the geographic proximity of at least one of the first arc and the second arc, a fourth electrode that creates a fourth arc on the workpiece using a fourth waveform within the geographic proximity of at least one of the first arc, the second arc, the third arc, or the fourth arc, and wherein the number of degrees is 90.

In an embodiment, the waveform manager component is further configured to identify a rising edge on at least one of the first waveform or the second waveform. In an embodiment, the waveform manager component adjusts a phase of at least one of the first waveform or the second waveform such that one of the following is provided: the rising edge of the first waveform does not occur at a time of a rising edge of the second waveform; the rising edge of the second waveform does not occur at a time of a rising edge of the first waveform; or the rising edge of the first waveform or the second waveform does not occur at a time of a rising edge of an additional waveform used on the workpiece.

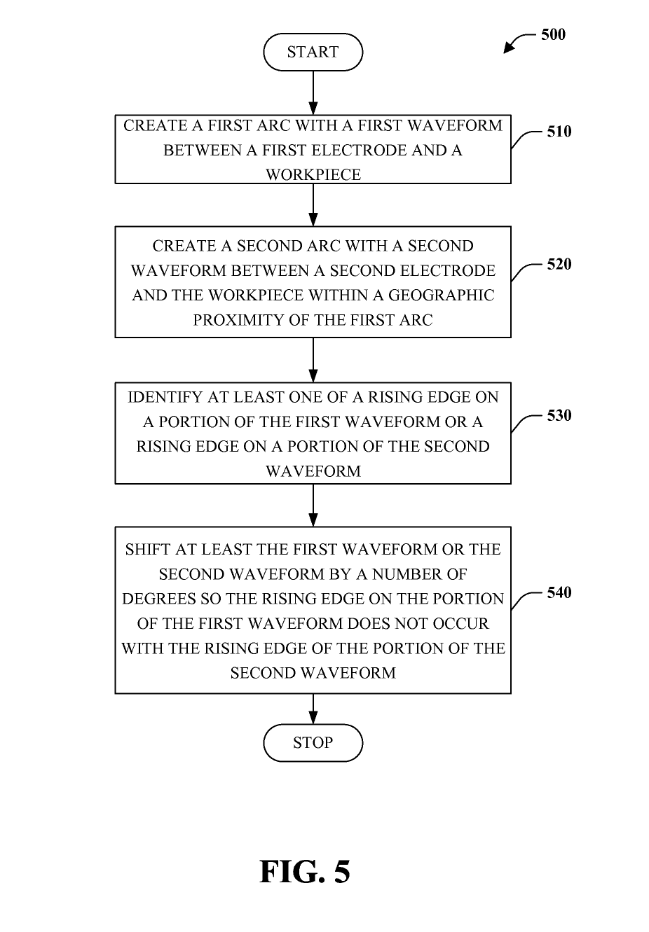

In view of the exemplary devices and elements described supra, methodologies that may be implemented in accordance with the disclosed subject matter will be better appreciated with reference to the flow chart and/or methodologies of FIGS. 5-7. The methodologies and/or flow diagrams are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods and/or flow diagrams described hereinafter.

The following occurs as illustrated in the decision tree flow diagram 500 of FIG. 5 which is a flow diagram 500 that reduces interference between two or more arcs created to perform a welding operation on a workpiece. At reference block 510, a first arc can be created with a first waveform between a first electrode and a workpiece. At reference block 520, a second arc can be created with a second waveform between a second electrode and the workpiece within a geographic proximity of the first arc. At reference block 530, at least one of a rising edge on a portion of the first waveform or a rising edge on a portion of the second waveform can be identified. At reference block 540, at least the first waveform or the second waveform can be shifted by a number of degrees so the rising edge on the portion of the first waveform does not occur with the rising edge of the portion of the second waveform.

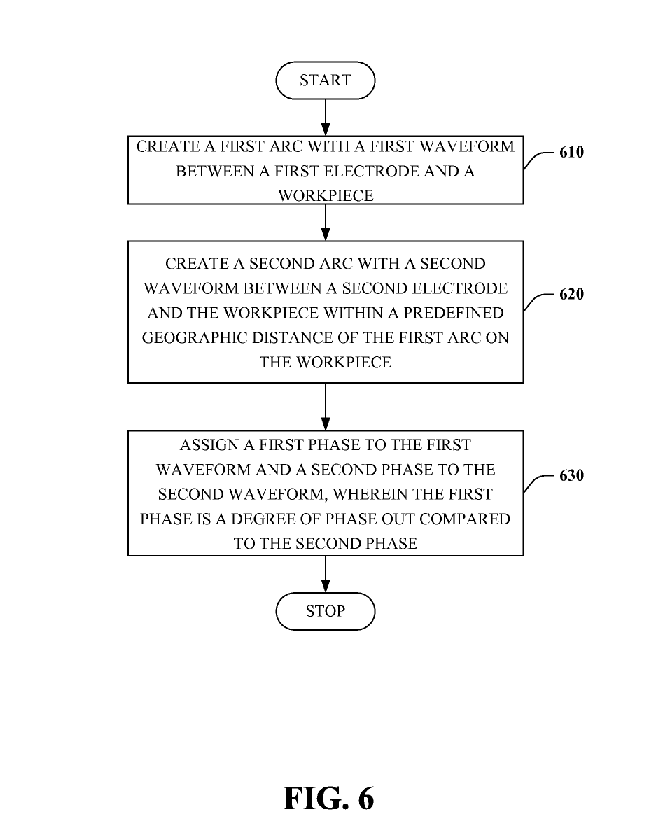

The following occurs as illustrated in the decision tree flow diagram 600 of FIG. 6 which is a flow diagram 600 that reduces interference between two or more arcs created to perform a welding operation on a workpiece. At reference block 610, a first arc with a first waveform can be created between a first electrode and a workpiece. At reference block 620, a second arc with a second waveform can be created between a second electrode and the workpiece within a predefined geographic distance of the first arc on the workpiece. At reference block 630, a first phase can be assigned to the first waveform and a second phase can be assigned to the second waveform, wherein the first phase is a degree of phase out compared to the second phase.

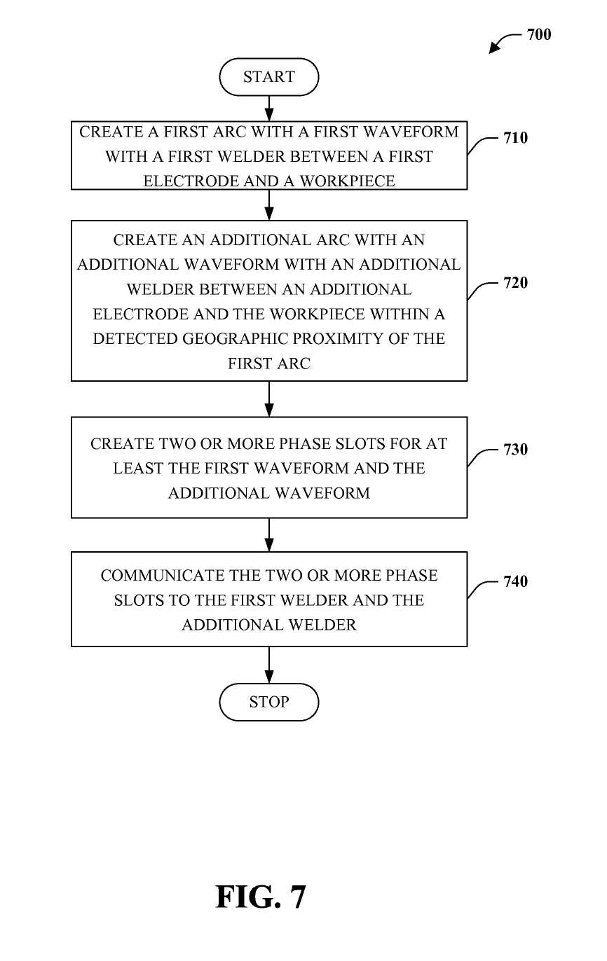

The following occurs as illustrated in the decision tree flow diagram 700 of FIG. 7 which is a flow diagram 700 that reduces interference between two or more arcs created to perform a welding operation on a workpiece. At reference block 710, a first arc can be created with a first waveform with a first welder between a first electrode and a workpiece. At reference block 720, an additional arc can be created with an additional waveform with an additional welder between an additional electrode and the workpiece within a detected geographic proximity of the first arc. At reference block 730, two or more phase slots can be created for at least the first waveform and the additional waveform. At reference block 740, the two or more phase slots can be communicated to the first welder and the additional welder.

Generally, the welding parameter can be, but is not limited to being, a welding parameter that affects the welding operation. Yet, it is to be appreciated that the welding parameter can be, but is not limited to being, an arc voltage, a travel speed of the torch 26 that performs the welding operation, an amplitude of the waveform, a current of the waveform, a voltage of the waveform, a frequency of the waveform, a wire feed speed, an arc current level, a height of the torch 26, a distance between workpiece W and torch 26, an oscillation width of electrode, a temperature of welding wire, a temperature of electrode, a type of material of workpiece W, a frequency of oscillation of electrode, a polarity of the arc current, a polarity of the current for welding wire, a parameter that affects an arc current of the welding operation, a type of electrode, a gauge of wire, a material of wire, and the like.

In an embodiment of the method, the number of degrees is 180. In an embodiment of the method, the geographic proximity is less than approximately one (1) foot and less than approximately ten (10) feet. In an embodiment, the method can further include creating an additional arc with an additional waveform between an additional electrode and the workpiece within the geographic proximity between the additional arc and at least one of first arc or the second arc. In an embodiment of the method, the number of degrees is 90.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

1. A welder system, comprising:
one or more welding power supplies which provide an alternating current in the form of one or more welding waveforms to a first electrode and a second electrode to respectively create a first arc between the first electrode and a workpiece and a second arc between second electrode and the workpiece during a welding operation;
the one or more welding waveforms includes a first welding waveform used with the first arc at a frequency and a second welding waveform used with the second arc at the frequency, each welding waveform having a respective peak current, and the first arc and the second arc are within a geographic proximity to one another during the welding operation on the workpiece; and
a waveform manager component that is configured to identify the geographic proximity of the first arc and the second arc, and based on the geographic proximity, adjust a time of occurrence for each respective peak current of the first welding waveform or the second welding waveform such that each respective peak current occurs at a different time during the welding operation on the workpiece, the adjust of the time prevents a magnetic field interference between the first arc and the second arc on the workpiece during the welding operation.

2. The welder system of claim 1, wherein the geographic proximity is identified by a user input.

3. The welder system of claim 1, further comprising
a first torch that delivers a wire to a puddle created by the first arc on the workpiece; and
a second torch that delivers a wire to a puddle created by the second arc on the workpiece.

4. The welder system of claim 3, wherein the geographic proximity is identified by a wireless signal communicated by the first torch and the second torch.

5. The welder system of claim 1, wherein the geographic proximity is greater than approximately one (1) foot and less than approximately fifteen (15) feet.

6. The welder system of claim 1, wherein the geographic proximity is less greater than approximately one (1) foot and less than approximately ten (10) feet.

7. The welder system of claim 1, further comprising a communication component that is configured to receive at least one of data representative of the first waveform, data representative of the second waveform, data representative of a parameter of the first waveform, or data representative of a parameter of the second waveform.

8. The welder system of claim 7, the communication component is further configured to communicate data representative of the time of occurrence to each of the one or more welding power supplies.

9. The welder system of claim 1, further comprising an assign component that is configured to generate a phase slot for each waveform used by the one or more welding power supplies, wherein each phase slot is a number of degrees out of one another.

10. The welder system of claim 9, wherein the number of degrees is 180.

11. The welder system of claim 9, further comprising a third electrode that creates a third arc on the workpiece using a third waveform within the geographic proximity of at least one of the first arc or the second arc, wherein the number of degrees is 120.

12. The welder system of claim 9, further comprising:
a third electrode that creates a third arc on the workpiece using a third waveform within the geographic proximity of at least one of the first arc and the second arc;
a fourth electrode that creates a fourth arc on the workpiece using a fourth waveform within the geographic proximity of at least one of the first arc, the second arc, the third arc, or the fourth arc; and
wherein the number of degrees is 90.

13. The welder system of claim 1, wherein the waveform manager component is further configured to identify a rising edge on at least one of the first waveform or the second waveform.

14. The welder system of claim 13, wherein the waveform manager component adjusts a phase of at least one of the first waveform or the second waveform such that one of the following is provided:
the rising edge of the first waveform does not occur at a time of a rising edge of the second waveform;
the rising edge of the second waveform does not occur at a time of a rising edge of the first waveform; or
the rising edge of the first waveform or the second waveform does not occur at a time of a rising edge of an additional waveform used on the workpiece.

15. A method of welding, comprising:
creating a first arc with a first waveform between a first electrode and a workpiece;
creating a second arc with a second waveform between a second electrode and the workpiece within a geographic proximity of the first arc;
identifying at least one of a rising edge on a portion of the first waveform or a rising edge on a portion of the second waveform; and
shifting at least the first waveform or the second waveform by a number of degrees so the rising edge on the portion of the first waveform does not occur with the rising edge of the portion of the second waveform.

16. The method of claim 15, wherein the number of degrees is 180.

17. The method of claim 15, wherein the geographic proximity is less greater than approximately one (1) foot and less than approximately ten (10) feet.

18. The method of claim 15, further comprising creating an additional arc with an additional waveform between an additional electrode and the workpiece within the geographic proximity between the additional arc and at least one of first arc or the second arc.

19. The method of claim 18, wherein the number of degrees is 90.

20. A welding system, comprising:
a first welder that creates a first arc with a first waveform between a first electrode and a workpiece;
a second welder that creates a second arc with a second waveform between the second electrode and the workpiece;
a proximity detector component that is configured to identify a geographic proximity between the first arc and the second arc performing a welding operation on the workpiece;
a waveform manager component that is configured to identify a first frequency for the first waveform and a second frequency for the second waveform;
if the first frequency is equal to the second frequency, the waveform manager component is further configured to adjust a time of occurrence for each respective peak current of the first welding waveform or the second welding waveform such that each respective peak current occurs at a different time during the welding operation on the workpiece; and
if the first frequency is not equal to the second frequency, the waveform manager component is further configured to adjust one of a phase of the first waveform or a phase of the second waveform such that a rising edge of a portion of the first waveform does not occur during a rising edge of a portion of the second waveform.
